(19) United States
(12) Patent Application Publication
(10) Pub. No.: US 2001/0047643 A1
(43) Pub. Date: Dec. 6, 2001

(54) TREE SHAKER PAD

(76) Inventor: RICHARD L. PALINKAS, NORTHFIELD, CT (US)

Correspondence Address: RAYMOND D THOMPSON, UNIROYAL CHEMICAL COMPANY INC, WORLD HEADQUARTERS, MIDDLEBURY, CT, 06749

(21) Appl. No.: 09/406,666

(22) Filed: Sep. 27, 1999

(51) Int. Cl. A01D 46/00

(52) U.S. Cl. 56/340.1; 56/328.1

(57) ABSTRACT

In a tree shaking apparatus a pad positionable between the trunk of a tree to be shaken, and the apparatus itself, includes a pair of end sections. Each end section defines a bore extending therethrough for receiving a post extending from the apparatus, thereby mounting the pad on the apparatus. A resilient polymeric web extends between the end sections and defines a first surface for engaging the trunk of a tree to be shaken.

### FIELD OF THE INVENTION

The present invention relates generally to an apparatus for harvesting fruit and/or nuts from the trees upon which they grow and deals more particularly with machinery for vibrating the trunks of these trees to dislodge the fruit or nuts therefrom for harvesting.

### BACKGROUND OF THE INVENTION

Most nuts, olives, and some fruit are harvested using a tree shaker. These machines usually provide a mechanism for gripping a tree's trunk and shaking the tree thereby causing ripened nuts, olives, or fruit to fall to the ground or onto a collecting apron spread under the tree. Tree shaking devices typically include a pair of arms extending from a vehicle, which can be actuated to grip and vibrate the tree trunk. The protect the tree and to enhance the ability of the arms to grip the tree's trunk, a pad is positioned between each of the arms and the tree.

In general these pads are in the form of hollow natural rubber cylinders, one mounted on each of the arms between the arm and the tree. A difficulty associated with these known natural rubber pads is that during operation the vibratory forces generated by the tree shaker induce friction between the rubber pad and the tree. This friction causes the pads to overheat which in turn degrades the rubber resulting in decreased pad life. In addition, the prior art pads tend to be somewhat hard and can themselves damage the tree. Pads of softer rubber better conform to the shape of the trunk and thus distribute forces more efficiently, but the pads wear out faster.

Based on the foregoing, it is the general object of the present invention to provide a pad for use with tree shaking equipment that overcomes the difficulties and drawbacks of prior art equipment.

It is a more specific object of the present invention to provide a pad for use between the trunk of a tree and the tree shaking equipment, that does not degrade as a result of frictional heat build up, as do known prior art pads.

### SUMMARY OF THE INVENTION

In accordance with the present invention, a pad for use with tree shaking equipment includes a pair of end sections each defining a bore extending therethrough. These bores are each adapted to receive a post that forms part of a shaker head on a tree shaking device, thereby mounting the pads to the shaker head. A web of resilient polymeric material extends between the end sections and during operation, engages the trunk of the tree to be shaken. During operation, the tree is vibrated by the tree shaker causing the nuts or fruit to dislodge from the trees branches and fall to the ground.

To absorb the vibratory loads and any heated generated from friction during operation of the tree shaker, the web is made from a suitable material, such as polyurethane which is resistant to high temperature degradation, and has a higher modulus of elasticity than the rubbers currently used to make pads for tree shakers.

During operation of a tree shaker employing pads made in accordance with the present invention, it is possible that large strains and shear forces can be induced in the pad to the detriment of the pad's useful life. In order to alleviate these shear stresses and strains, the pads can incorporate apertures extending at least part way therethrough. Preferably, these apertures are positioned between the end sections of the pad adjacent to the above-described bores.

### BRIEF DESCRIPTION OF THE DRAWINGS

A more complete understanding of the present invention and its attendant advantages will be readily understood by reference to the following detailed description considered in conjunction with the accompanying drawings. Corresponding reference characters indicate corresponding components of the several drawings, and:

FIG. 1 is a partly in section perspective view of the tree shaker pad of the present invention.

FIG. 2 is a top view of the tree shaker pad as applied to a tree trunk.

### DETAILED DESCRIPTION OF THE PREFERRED EMBODIMENT

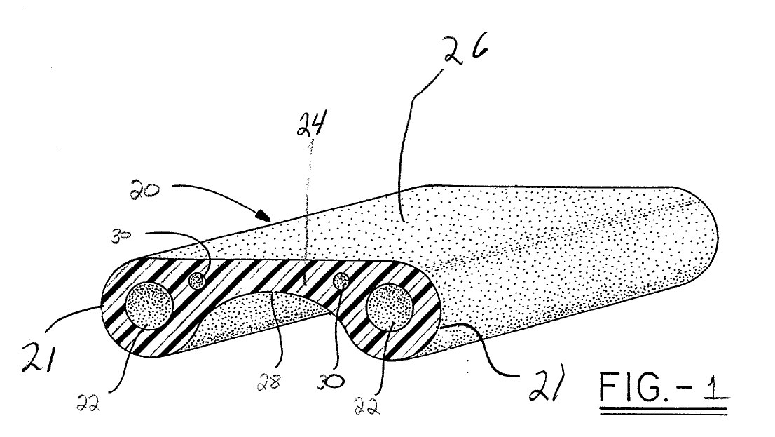

As shown in FIG. 1, a tree shaker pad of the present invention for use with conventional tree shaking machines is generally designated by the reference number 20. The pad 20 includes a pair of generally cylindrical end sections 21, each defining a bore 22 extending axially therethrough. The bores 22 are approximately parallel to one another and are each adapted to releasably receive at least one mounting post that extends from a tree shaker head (not shown) extending from the tree shaking machine. A resilient web 24 extends between the end sections 21 and is made from a suitable material, such as, but not limited to polyurethane.

Still referring to FIG. 1, the web 24 is defined by an approximately planar first surface 26, that engages the trunk of a tree to be shaken, and a concave second surface 28 opposite the first surface. During operation, the concavity of the second surface 28, facilitates the engagement of the pad 20 with differently sized tree trunks by allowing the first surface 26 to readily wrap around, and conform to the shape and size of the different trunks.

During operation of the tree shaker the pad 20 is subjected to shear forces and strains that have the potential to damage the pad. Accordingly, in the preferred embodiment of the present invention, a pair of apertures 30 are defined by the pad 20, one positioned adjacent to each of the bores 22 and extending at least part way through the pad's width to relieve the strains induced in the pad during operation.

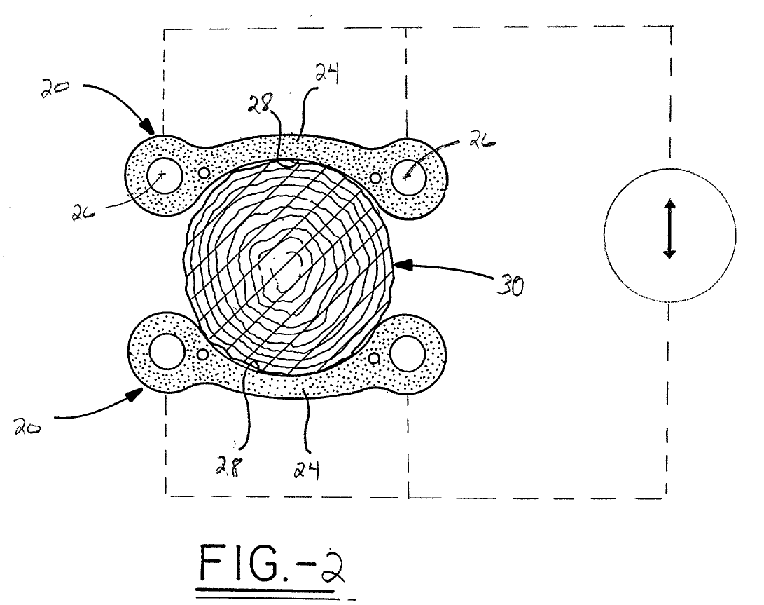

As shown in FIG. 2, a tree shaker employs a pair of pads 20 opposite one another, each engaging the trunk of the tree to be shaken. When positioned against a tree, the bores 22 are approximately parallel to the tree trunk 30, as well as to each other. During operation, vibratory forces are transmitted from the tree shaker, to the pads 20 and to the tree.

The above preferred and alternative embodiments are illustrative rather than exhaustive, and may be combined in whole or in part to attain a particular set of advantages. Such combinations, and modifications thereof, are within the scope of this disclosure and will be apparent to those skilled in the art consistent with the teachings herein. The scope of the following claims encompass such modifications and variations in accordance with the Doctrine of Equivalents.

What is claimed is:

1. A pad coupled to a tree shaking apparatus, between the apparatus and the trunk of a tree to be shaken, said pad comprising:
a pair of opposing end sections, each defining a bore extending longitudinally therethrough, and adapted to receive a mounting member coupled to the tree shaker, and
a resilient polymeric web extending between and coupled to said end sections, said web defining a first surface for engaging said tree trunk.

2. A pad as defined by claim 1 wherein said bores are approximately parallel to each other.

3. A pad as defined by claim 1, wherein said web is fabricated from polyurethane.

4. A pad as defined by claim 1 wherein said end sections are fabricated from polyurethane.

5. A pad as defined by claim 1 wherein at least one aperture is positioned adjacent to each end section for providing strain relief in the pad during operation of the tree shaking apparatus.

6. A pad as defined by claim 1 wherein said end sections and said web are fabricated from polyethylene.

7. A pad coupled to a tree shaking apparatus, between the apparatus and the trunk of a tree to be shaken, said pad comprising:
a pair of opposing end sections, each defining a bore extending longitudinally therethrough, and adapted to receive a mounting member coupled to the tree shaker;
a resilient polymeric web extending between and coupled to said end sections, said web defining a first surface for engaging said tree trunk; and wherein
said pad defines a pair of apertures approximately parallel to said bores and extending at least part way through said pad, each of said apertures being positioned adjacent to one of said bores.
